(19) United States
(12) Patent Application Publication
(10) Pub. No.: US 2010/0100429 A1
(43) Pub. Date: Apr. 22, 2010

(54) SYSTEMS AND METHODS FOR USING WORLD-SPACE COORDINATES OF AD OBJECTS AND CAMERA INFORMATION FOR ADVERSTISING WITHIN A VITRTUAL ENVIRONMENT

(75) Inventors: MATTHEW E. McCLOSKEY, Franklin Square, NY (US); SHAWN SHERIDAN, Brooklyn, NY (US); MAKSIM NOY, New York, NY (US); SIMON S. YUN, Merrick, NY (US); CHRISTOPHER HAZEN, Montclair, NJ (US); JEFFREY D. CARNAHAN, Kirkland, WA (US)

Correspondence Address: SHOOK, HARDY & BACON L.L.P.;(MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 12/253,841

(22) Filed: Oct. 17, 2008

(51) Int. Cl. G06Q 30/00

(52) U.S. Cl. 705/14.12

(57) ABSTRACT

An ad system for use in a virtual environment. The ad system includes an ad engine integrated in an advertising enabled application, an advertising scheduling system, reporting software, impression metric processing software, and billing components wherein coordinates of ad object and camera data were made available to the ad engine during development of the application. Related methods of developing advertising enabled application software including an ad engine and use of a computer system for delivering ad content within a virtual environment are also provided.

### TECHNICAL FIELD

This invention relates in general to virtual environments, and in particular, to advertising in such environments. More specifically, but without restriction to the particular embodiments hereinafter described in accordance with the best mode of practice, this invention relates to systems and methods for using world-space coordinates of ad objects and camera information for advertising within a virtual environment.

### BACKGROUND

Existing ad systems for virtual environments rely on objects and code within a game, for example, to perform their own calculation of ad impressions. Game developers are responsible for calculating impression metrics (size and viewing angle of ads on screen) that they then report to the ad engine, which is unaware of any game or ad object geometry. In the realm of game development, placing this responsibility on game developers complicates integration of the ad engine into the game because game developers need to perform the unfamiliar task of calculating impression metrics, leaving room for error in the in-game impression calculations. Because each game implements its own impression metric calculation, the impression metric calculation must be tested on every game. Furthermore, since the advertising engine is unaware of game and ad object geometry, each game requires manual play testing to verify ad placements.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The inventors hereof have implemented methods and systems that in a particular embodiment of a specific application of the inventions herein disclosed, allow a software game to make coordinates of ad objects and camera data available to an ad engine. The ad engine may advantageously use this information to perform automatic impression metric calculations, removing that burden and source of potential error from game developers. By providing a single point of impression calculation in the ad engine according to the teachings hereof means that impression calculations no longer need to be tested in each game; only the ad object and camera coordinates passed to the ad engine need to be verified for correctness. Since the ad engine is now aware of game and ad object geometry, this information can be used to drive automated testing for ad placement verification. It can also be used to generate information about game play which can then be leveraged during the ad placement optimization process.

The inventions disclosed herein and the related teachings directed to computer system implementations are not necessarily limited to game software development, but may be readily applied to development of any application software as well as website development, digital radio, or any software application employed by an end user of a computer system.

More specifically now according to certain embodiments of the present invention, there is provided systems and methods for using world-space coordinates of ad objects and camera information for advertising within a virtual environment. One particular embodiment of a specific method hereof provides the ability to (1) maintain a set of ad objects defined in the virtual environment and automatically perform ad metric impression calculations on the objects, (2) track and maintain a camera object in the virtual environment for use in generating automated ad impression calculations, (3) generate a heat map of an environment that details which areas of the environment a player has traversed, and (4) determine the best placements for advertisements.

In accordance with one aspect of this invention, there is specifically provided an ad system for use in a virtual environment. One particular embodiment of the ad system advantageously includes an ad engine integrated in an advertising enabled application; an advertising scheduling system; reporting software; impression metric processing software; and billing components wherein coordinates of ad object and camera data were made available to the ad engine during development of the application. In a particular implementation thereof, the ad engine of the ad system receives ads from a local source, a remote source, or both. This ad system may further include a set of ad objects defined in the virtual environment and provided functionality so that ad metric impression calculations are performed on the set of ad objects. The ad metric impression calculations may be performed using given data, or using, calculated data, or they may be calculated by using both given data and calculated data. In a further detailed embodiment of the ad system according to the present invention, there is provided functionality for tracking a camera object in the virtual environment for use in generating automated ad impression calculations, and similarly the system may include functionality for maintaining a camera object in the virtual environment for use in generating automated ad impression calculations.

According to another aspect of certain embodiments of the present invention there is further provided a method of developing advertising enabled application software including an ad engine. This method includes the steps of (1) making coordinates of ad object and camera data available to the ad engine during development of the application; and (2) using the ad object and camera coordinates to perform automatic impression metric calculations within the ad engine. This method may further include, in combination or individually, the additional steps of passing the ad object and camera coordinates to the ad engine to verify correctness thereof; making the ad engine aware of application and ad object geometry; and/or using application and ad object geometry information to drive automated testing for ad placement verification.

In accordance with yet another aspect of this invention, there is further provided teaching relating to the use of a computer system for delivering ad content within a virtual environment. Here, the computer system is implemented to include memory for storing an advertising enabled application including an ad engine wherein coordinates of ad object and camera data were made available to the ad engine during development of the application; a processor for running the advertising enabled application so that ad objects are made available to a user of the application, the processor using the ad object and camera coordinates to perform automatic impression metric calculations within the ad engine during use of the application; and a presentation component associated with the processor, the presentation component providing an interface with the user so that ad content associated with the ad objects is delivered to the user during use of the application. In one embodiment hereof, the advertising enabled application includes game software.

According to one aspect hereof, coordinates of the ad objects are made available to the ad engine, and in certain instances a specific set of ad objects are defined in the virtual environment. In this case, ad metric impression calculations are performed on the set of ad objects. The ad metric impression calculations may be performed by using given data, by using calculated data, or by using both given and calculated data.

### BRIEF DESCRIPTION OF THE DRAWING FIGURES

Further aspects and characteristics of the embodiments of the present invention together with additional features contributing thereto and advantages accruing therefrom will be apparent from the following description of certain embodiments of the invention which are shown in the accompanying drawing, wherein:

FIG. 1 is a block diagram representing typical elements in a computer operating environment in which embodiments of the present invention may be implemented;

FIG. 2 is a block diagram of an embodiment of an ad system according to this invention; and

FIG. 3 is a process flow diagram illustrating certain methods in accordance with particular embodiments of the present invention.

### DETAILED DESCRIPTION

The subject matter of the embodiments of the present invention is described with specificity herein to meet statutory requirements. However, the description itself is not intended to limit the scope of this patent. Rather, the inventors have contemplated that the claimed subject matter might also be embodied in other ways, include different steps or combinations of steps similar to the ones described in this document, or used in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

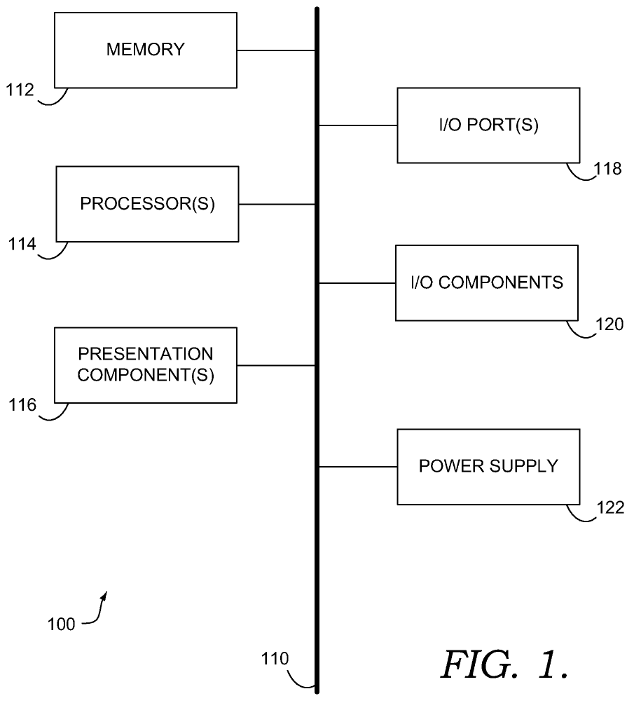

Having briefly described above an overview of certain embodiments of the present invention, an exemplary operating environment for the various embodiments of this invention is next described. Referring now to FIG. 1, an exemplary operating environment for implementing embodiments of the present invention is shown and designated generally as computing system or device 100. Computing device 100 is just one example of a suitable computing environment and is not intended to suggest any limitation as to the scope of use or functionality of the invention. The inventors hereof envision that the inventions disclosed herein may be readily applied in a wide range of computing devices, systems, or environments whether networked or stand alone including for example, desktop PCs, hand-held computing devices, navigation systems, digital radios, home entertainment systems, and any other computing environment where placements of ads, either audio/visual or audio only, is desired. Furthermore, the inventors hereof believe that emerging technologies will soon allow a computer user to experience smell, aroma, or fragrance as well as tactile feel such as rough, smooth, hot, or cold while using the computer system and involved in any one of a variety of different activities in a virtual world such as, for example, shopping, training, playing games, browsing, performing research and marketing, or enjoying various types of entertainment. Thus the computing environment 100 should not be construed as having any particular dependency or requirement relating to any one or combination of the components or modules illustrated. Certain aspects and embodiments of the present inventions may be described in the general context of computer code or machine-useable instructions, including computer-executable instructions such as program components, being executed by a computer or other machine, such as a personal data assistant or other handheld device as discussed above. Generally, program components including routines, programs, objects, components, data structures, and the like, refer to code that performs particular tasks, or implement particular abstract data types. Embodiments of the present invention may be practiced in a variety of system configurations, including hand-held devices, consumer electronics, general-purpose computers, specialty computing devices, and so forth, whether known today or developed subsequently hereto. Embodiments of the invention may also be practiced in distributed computing environments where tasks are performed by remote-processing devices that are linked through a communications network.

With continued reference to FIG. 1, computing system 100 includes a bus 110 that directly or indirectly couples a memory 112, one or more processors 114, one or more presentation components 116, input/output (I/O) ports 118, I/O components 120, and an illustrative power supply 122. Bus 110 represents what may be one or more buses such as those that may include an address bus, a data bus, or a combination thereof. Although the various blocks of FIG. 1 are shown with solid line connections which may represent a hard wire connection, any one or more of the elements may be wirelessly connected where desired, appropriate, or technically feasible. In addition thereto, certain hardware/software implementations hereof may include a wide variety of various components and functionalities so the elements illustrated in FIG. 1 are to be taken only as exemplary and not limiting in any intended or particular manner. For example, one may consider a presentation component such as a display to be an I/O component. Also, processors have memory as those skilled in the art would readily appreciate. The inventors hereof recognize that such is the nature of the art, and reiterate that the diagram of FIG. 1 is merely illustrative of an exemplary computing device or system that can be used in connection with one or more embodiments of the present invention. Distinction is not made between such categories as “workstation,” “server,” “laptop,” “hand-held device,” or the like, as all are contemplated within the scope of FIG. 1 and reference to as “computer”, “computing device”, or “computing system.”

Now more specifically, the computer 110 typically includes a variety of computer-readable media. Computer-readable media includes any available media that can be accessed by computer 110 and encompasses both volatile and nonvolatile media, as well as removable and non-removable media. By way of example, and not limitation, computer-readable media may include computer storage media and communication media. Computer storage media includes such volatile and nonvolatile, removable and non-removable media implemented in any method or technology for storage of information such as computer-readable instructions, data structures, program modules or other data. More specifically, computer storage media includes, but is not limited to, RAM, ROM, EEPROM, flash memory or other memory technology, CD-ROM, digital versatile discs (DVD) or other optical disc storage such as Blu-ray or HD-DVD, magnetic cassettes, magnetic tape, magnetic disk storage or other magnetic storage devices, or any other medium which may be used to store the desired information and which can be accessed by computer 110. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope and meaning of computer-readable media.

Memory 112 includes computer-storage media in the form of volatile and/or nonvolatile memory. The memory 112 may be removable, non-removable, or a combination thereof. Exemplary hardware devices include solid-state memory, hard drives, optical-disc drives, and other such current or future devices that would provide the desired functionality. Computing device 100 includes one or more processors 114 that read data from various entities such as memory 112 or I/O components 120. Presentation component(s) 116 present data and/or sensory indications to a user or other device. Exemplary presentation components include a video display, speaker, printing component, vibrating component, and any such current or future presentation components which may include smell or a tactile feeling sensations such as rough, smooth, hot, warm, or, cold, for example. I/O ports 118 allow computing device 100 to be logically coupled to other devices, including I/O components 120, some of which may be built in. Illustrative components include a microphone, joystick, game pad, satellite dish, scanner, printer, wireless device, and others as desired, appropriate, or technically feasible.

As discussed briefly above, the inventions hereof may be implemented specifically in a software game environment and more generally in any virtual environment including application software. Thus in this general environment, certain specific elements and functionalities become relevant. For example, the inventions hereof may be implemented in any desired virtual world. As one of skill in the art would appreciate, the term virtual world refers to a computer implemented simulated environment. Exemplary virtual worlds may include, for example, massively multiplayer online role-playing games (“MMORPGs”), virtual social communities, virtual reality applications, websites, or computer assisted design (“CAD”) simulations.

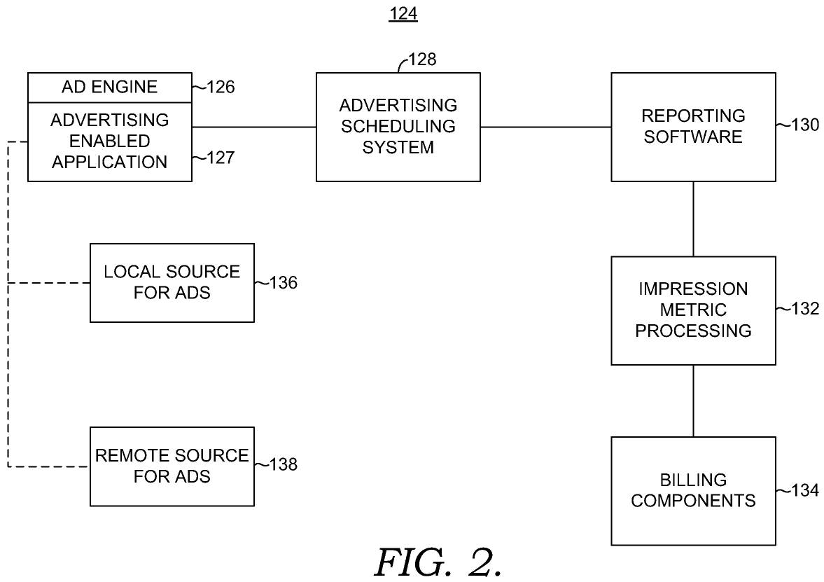

In the virtual worlds associated with the various embodiments of the present inventions, there may be introduced an ad system 124 as represented in FIG. 2. An ad system such as the ad system 124 typically includes a collection of software components that facilitate the delivery of advertising within virtual environments. In addition to an ad engine integrated with an advertising enabled application 126, the ad system 124 may include a advertising scheduling system 128, reporting software 130, impression metric processing software 132, and a billing component 134. The ad system 124 may also include other components and/or applications as needed or desired to operate an advertising business within a virtual world according to a wide variety of different specific implementations. As employed in this embodiment, the ad engine 126 may be preferably implemented as a code module integrated into the virtual world application 127. The ad engine 126 obtains advertisements from either a local source 136, a remote source 138 via a network connection such as over the Internet, for example, or both. Sourced advertisements are delivered by the ad engine 126 to the virtual world for placement in ad objects. The ad engine 126 collects ad impression data either reported by the virtual environment, or derived from camera data and/or other data provided by the virtual environment. The collected impression data (and/or other data relevant to advertising) is then saved locally or transmitted remotely. As employed herein, camera objects are objects in the virtual environment that define what a user can view or otherwise experience in a sensory manner. These objects describe what is visible, audible, or otherwise perceptively available to the user or observer via the environment. As employed in the visible realm, camera data contains any and all data used to define a camera object. The camera data can contain such items as the camera coordinates, field of view, near and far clipping planes and screen size, as well as other data. The camera coordinates contain information regarding the location of the camera in the virtual environment, such as its position, direction, and up vector. An ad object is an object or area where an advertisement can be delivered within the virtual world or environment. These ad objects can consist of anything that can be placed in the virtual environment. Some examples of visually perceived ad objects include two and three dimensional objects, such as billboards in a video game, or areas that are triggered to deliver an advertisement when the conditions of the trigger are met. The ad objects may be static within the virtual environment or dynamic. An example of a dynamic ad object includes an sign on top of a taxi that moves within the virtual environment. As the taxi moves away from the perspective of the application user, here a game for example, the car-top billboard as an ad object may be come smaller, and similarly as the taxi moves toward the perspective of the player of the game, the ad sign atop the taxi may become larger relative to other elements shown on the display and thus gradually become more predominant to the game-player user. An example of a trigger would be a location in a virtual world that gets activated when a camera object enters the trigger area. As employed herein, ad geometry contains information regarding the location, dimensions, and orientation of an ad object in the virtual environment and can include such data as its position, size, and direction.

As presentation components develop, a user of a computer system may soon be able to experience aroma and fragrance as well as tactile feel such as soft, smooth, and warm. Thus the inventors hereof believe that certain aspects and embodiments of the present invention may be readily adapted to providing ad objects that are associated with the senses of smell and touch. Thus extending advertising within the virtual world further to make such experiences more palpable to the user. Thus when shopping on-line for carpet or clothing, one may experience the feel or texture of the textile, and similarly when shopping for perfumes or coffee, for example, a potential purchaser may soon be able to experience the fragrance or aroma of such goods while using a virtual environment. Perfumes for example have long since been advertised in magazines with so called “scratch-and-sniff” inserts. And currently in various virtual worlds associated with computer systems, sensations associated with sight, sound, and vibration are used and delivered in presentation components such as video displays, speakers, and vibrating handheld control devices. When advertising motorcycles, for example, a characteristic engine sound or vibration may be delivered to a computer user. Just a few years ago, such was not technically feasible. Thus as emerging presentation technologies develop, the users of virtual world computing systems may eventually employ “click-and-sniff” or “click-and-feel” devices. This is anticipated to give marketers and advertisers more flexibility in delivering full sensory ad content to end users of computer systems and virtual environments thereby provided. And thus in connection therewith, many aspects and characteristics of the various embodiments of the present invention will be readily adaptable to these emerging presentation technologies as they eventually make their way into the marketplace.

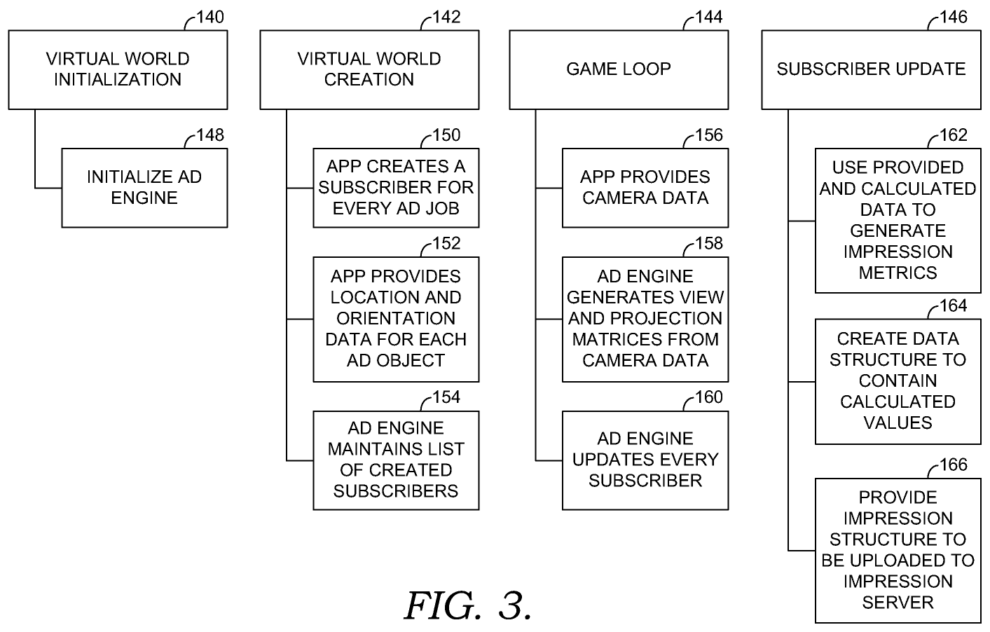

With reference next to FIG. 3, there is shown a process flow diagram illustrating certain methods in accordance with yet other embodiments of the present invention. The methods of these embodiments of the present invention may be illustrated as generally residing in four functional areas including, as shown, virtual world initialization 140, virtual world creation 142, game loop 144 in the case of a game implementation, and subscriber updates 146. Virtual world initialization 140 may include, as examples thereof, starting a game on a desk top PC, game console, or other game device; tuning into a digital radio station or satellite television broadcast in a home environment or in an automobile; accessing an application on a hand-held device such as a smart phone for example; stepping into an automobile or flight simulator for entertainment or training purposes; or tuning into interactive cable television. All of these different computer environments are to be considered within the purview of the various embodiments of the present invention and have in common the elements and functionalities generally discussed above in conjunction with FIG. 1. The virtual world initialization 140 may then be a first method step in any of the virtual world devices mentioned above. And upon virtual world initialization 140, the ad engine 126, FIG. 2, is initialized at step 148.

Now more particularly according to the teachings hereof, the system contains a set of application programming interfaces (API) that are exposed to a developer to allow the developer to describe to the ad engine the properties of the ad objects contained within the virtual environment. The process begins with the creation of the virtual environment itself at step 142. At this point the developer creates, for example and not by way of limitation, an instance of a C++ class object (a “subscriber” object) for every in-world ad object, containing the bounding volume and orientation of that ad object. Creating such is not limited to the use of C++ but as one of skill in the art would appreciate any suitable programming language such as, for example, C, C Sharp, Java, Perl, Assembly, Visual Basic, and/or others may be employed here. Furthermore, the various embodiments of the present invention are not specifically limited to the use of object oriented programming.

With continuing reference to FIG. 3, it should be understood that the ad engine internally maintains a list of all of the subscriber objects that have been created, and updates them every frame. Thus at the time of virtual world creation 142, that is during software development of the application which includes the ad engine, three principal steps are performed. At step 150, the application creates a subscriber for every ad job. At step 152, the application provides location and orientation data for each ad object. And at step 154, the ad engine maintains a list of created subscribers. Here, the ad engine is aware of all ad-objects (and their properties such as location, size, etc.), and that the ad engine is able to receive camera data. Once set up in this fashion, the application is ready to proceed. Camera data will be processed by the ad engine, compared to its knowledge of the ad objects, and impression metrics are automatically calculated.

One specific embodiment hereof, as discussed above, is implemented in game software. In this embodiment, game loop 144 is employed. Here the application provides camera data at step 156, and the ad engine generates view and projection matrices from the camera data at step 158. At step 160 in game loop 144, the ad engine updates every subscriber. As one of skill in the art would appreciate, here in this specific embodiment object instances as subscribers is just one particular instantiation of this aspect of the invention. Thus as indicated above, there are available and readily adaptable hereto alternate ways to program the ad engine hereof. Use of object instances known as subscribers is simply one approach presented as exemplary of this embodiment.

In connection with subscriber updates, preferably at every update interval within the virtual world, the environment provides data to the ad engine that describe the current characteristics of the in-world camera (current position, current forward vector, current up vector, camera field-of-view). In one specific embodiment hereof, the ad engine then uses these values to internally calculate a view and projection matrix. During this update interval, each of the subscriber objects maintained by the ad engine are then individually updated. By using the properties of the subscriber and the matrices calculated by the ad engine, the impression metrics for that subscriber are then generated. More generally and as applied in alternative embodiments hereof, the impression metrics for each ad-object are advantageously generated by using the properties of that ad-object and provided camera data.

By transforming the bounding volume points of the subscriber to screen-space, a size-on-screen value is generated. Also, the projected screen-space points can be used to determine if the ad object would currently appear on-screen for this particular frame. An angle value is also calculated by performing a dot product operation between the vector that describes the subscriber's orientation and the vector that describes the camera's viewing direction. The size-on-screen value is just one of many impression metrics as with the determination if an ad object is currently on screen or not.

After all of the impression metrics for a subscriber have been generated, the ad engine then generates a structure that contains all these values and passes it to a network manager, where the data is uploaded to a server for ad tracking. The server in this case is the advertising scheduling system 128 as shown if FIG.2. Alternatively, the statistics may be saved offline for a time, then uploaded to the ad scheduling system 128 at a later date when networking conditions are optimal or better. This may be the case where the user was offline, or his connection was saturated earlier.

As indicated above, the various embodiments of the present invention are not limited to game software implementations, nor is the presentation device necessarily a video monitor. Thus, for example, in the digital radio embodiment hereof, the “camera” characteristics may include volume as well as speaker configuration or orientation. In this alternate application hereof, the speaker system functions as the “camera” or the user's portal into the virtual environment. Furthermore, it is currently contemplated by the inventors hereof that there are other, more, and various impression metrics that may be automatically calculated in alternative or future applications hereof, or in currently available different operating environments such as the digital radio discussed above.

More specifically now with continued reference to FIG. 3, three main steps are performed in the subscriber update module 146. First, provided and calculated data are used to generate impression metrics at step 162. At step 164, the step of creating data structure to contain calculated values is performed. Next at step 166, impression structure is provided so that it may be uploaded to an impression server. More particularly, each ad object is evaluated to determine if impression metrics should be calculated, and if so, they are then calculated using the properties of the ad object, and the properties of the camera data. The resulting impression metrics (some type of appropriate or desired data structure) are then ready to be sent back to the advertising scheduling system 128 of FIG.2.

Thus given implementation of the present invention in an appropriate computer environment, the system and methods disclosed herein maintain a set of ad objects defined in the virtual environment and automatically perform ad metric impression calculations on these objects using the given and calculated data. The system is also enabled to track and maintain the camera object in the virtual environment for use in generating the automated ad impression calculations. The present system may further be employed to generate a ‘heat map’ of the virtual environment that identifies which areas of that environment the player has traversed. This information may then be advantageously employed to determine the best placements for advertisements within the virtual environment. For example, the map may represent a particular game level such as a race track, and the heat map color indicate areas of the race track where advertising is observed. The range of colors may then be advantageously employed to indicate low ad exposure (infrequent or short duration), to high ad exposure (frequent or long duration).

While this invention has been described in detail with reference to certain embodiments, it should be appreciated that the present invention is not limited to those precise embodiments. Rather, in view of the present disclosure which describes the current best mode for practicing the invention, many modifications and variations would present themselves to those of skill in the art without departing from the scope and spirit of this invention. The scope of the invention is, therefore, indicated by the following claims rather than by the foregoing description. All changes, modifications, and variations coming within the meaning and range of equivalency of the claims are to be considered within their scope.

1. A computerized ad system for advertising in a virtual environment, said ad system comprising:
an ad engine that performs automatic impression metric calculations using impression metric processing software, wherein ad object data and camera data are used to calculate the automatic impression metric calculations;
an advertising enabled application that includes a processor configured to execute said advertising enabled application such that executing said advertising enabled application allows the ad engine to access the ad object data and the camera data;
a presentation component that displays ad content to a user;
an advertising scheduling system; and
one or more billing components.

2. The ad system according to claim 1, wherein said ad engine receives ads from a local source.

3. The ad system according to claim 1, wherein said ad engine receives ads from a remote source.

4. The ad system according to claim 1, further including a set of ad objects defined in the virtual environment.

5. The ad system according to claim 4, wherein ad metric impression calculations are performed on said set of ad objects.

6. The ad system according to claim 5, wherein said ad metric impression calculations are performed using given data.

7. The ad system according to claim 5, wherein said ad metric impression calculations are performed using calculated data.

8. The ad system according to claim 1, further including a tracking component that tracks a camera object in the virtual environment, wherein results of the tracking component are used to generate automated ad impression calculations.

9. The ad system according to claim 1, further including a maintaining component that maintains a camera object in the virtual environment to generate automated ad impression calculations.

10. A computer-implemented method for advertising within a virtual environment, said method comprising:
storing an advertising enabled application including an ad engine, wherein coordinates of ad object data and camera data are available to the ad engine;
executing said advertising enabled application such that ad objects are available to a user of the advertising enabled application, wherein the ad object data and camera coordinates are used to calculate automatic impression metric calculations within the ad engine during use of the advertising enabled application; and
displaying an interface to the user so that ad content associated with said ad objects is delivered to the user during use of the advertising enabled application.

11. The method of claim 10, wherein said advertising enabled application includes game software.

12. The method of claim 10, wherein coordinates of said ad objects are available to said ad engine.

13. The method of claim 12, wherein said ad objects include a specific set of ad objects defined in the virtual environment.

14. The method of claim 13, wherein ad metric impression calculations are performed on said set of ad objects.

15. The method of claim 13, wherein said ad metric impression calculations are performed using given data.

16. The method of claim 13, wherein said ad metric impression calculations are performed using calculated data.

17. One or more computer-storage media having computer-executable instructions embodied thereon that, when executed, perform a method of advertising within a virtual environment, said method comprising the steps of:
providing coordinates of ad object data and camera data such that the coordinates are available to the ad engine; and
performing automatic impression metric calculations within the ad engine using the ad object data and camera coordinates.

18. The media according to claim 17, further including the step of passing the ad object data and camera data coordinates to the ad engine to verify correctness thereof.

19. The media according to claim 18, further including the step of making the ad engine aware of an application and ad object geometry.

20. The media according to claim 19, further including the step of using the application and ad object geometry to drive automated testing for ad placement verification.
